(19) United States
(12) Patent Application Publication
(10) Pub. No.: US 2005/0116688 A1
(43) Pub. Date: Jun. 2, 2005

(54) Power source with an anti-reverse connection and short circuit protection circuit for starting motor vehicles

(75) Inventors: Keshu Yin, Foshan City (CN); Song Hua Yu, Foshan City (CN)

Correspondence Address: Mr. Eric Chan, 42 Pin Oaks Drive, Phoenixville, PA, 19460, US

(73) Assignee: Li, Weiguang, Foshan City (CN)

(21) Appl. No.: 10/951,016

(22) Filed: Sep. 28, 2004

(30) Foreign Application Priority Data
Nov. 28, 2003 (CN) 2003201186429

(51) Int. Cl. H02J 7/04

(52) U.S. Cl. 320/165

(57) ABSTRACT

The present invention relates to a power source with an anti-reverse connection and short circuit protection circuit for starting motor vehicles comprising a rechargeable battery, a flash light circuit, a positive battery clamp, a negative battery clamp and a circuit which comprises two relays and at least two diodes; one terminal of each relay is connected to the positive battery clamp; the other terminal of the first relay is connected to the positive terminal of the first diode and the negative terminal of the first diode is connected to the negative battery clamp; the other terminal of the second relay is connected to the negative terminal of the second diode and the positive terminal of the second diode is connected to the negative battery clamp. The power source provides an effective circuit protecting against reverse polarity connection and short circuit of the battery clamps.

### BACKGROUND OF THE INVENTION

The present invention relates to a power source for starting motor vehicles and more particularly pertains to a power source with a circuit for protecting against reverse polarity connection and short circuit of the battery clamps during jump starting of a motor vehicle's engine.

A power source is used for jump starting a motor vehicle's engine when the vehicle's battery has no or insufficient power. A power source generally comprises a battery and two battery clamps which are connected to the positive and negative terminals of the battery respectively. It operates through the connection of the two battery clamps to the two terminals of the vehicle's battery so as to jump start the vehicle's engine. At present, the available power sources for starting motor vehicles in the marketplace do not have any effective circuit protecting against reverse polarity connection and short circuit of the battery clamps. When the two battery clamps of the power source are reversely connected to the polarity of the vehicle's battery, such reverse polarity connection will badly damage the vehicle's battery and will generate high current and sparks, which may cause a fire.

It is known that an existing power source generally comprises a power source, a capacitor, a resistor and a switch. The capacitor is connected in parallel via the switch with the two terminals of the power source. One terminal of the resistor is connected to the positive polarity of the capacitor and the other terminal is connected via the switch with the positive polarity of the power source. The power source is an imbibing sealed maintenance-free battery. The capacitor is an electrolysis capacitor of high capacity. The switch is a three-gear switch. When the switch is turned to the “ready” gear, the power source, the resistor and the capacitor form a series circuit. When the switch is turned to the “on” gear, the capacitor and the power source are connected in a parallel arrangement. Such a configuration provides no protection against reverse polarity connection and short circuit. When the two battery clamps of the power source are reversely connected to the polarity of the vehicle's battery, the vehicle's battery will be badly damaged and possible danger of fire will be caused.

### BRIEF SUMMARY OF THE INVENTION

In view of the aforesaid disadvantages now present in the prior art, the present invention provides a new power source with an anti-reverse connection and short circuit protection circuit for starting motor vehicles.

To attain this, the power source of the present invention generally comprises a rechargeable battery, a flash light circuit, a positive battery clamp which is connected via a normally open contact relay to the positive terminal of the rechargeable battery, a negative battery clamp which is connected to the negative terminal of the rechargeable battery, and a circuit for protecting against reverse polarity connection and short circuit of the battery clamps; wherein said circuit comprises said first relay and another second relay and at least two diodes; one terminal of the wire coils of the first relay and the second relay are connected to the positive battery clamp; the other terminal of the wire coil of the first relay is connected to the positive terminal of the first diode and the negative terminal of the first diode is connected to the negative battery clamp; the other terminal of the wire coil of the second relay is connected to the negative terminal of the second diode and the positive terminal of the second diode is connected to the negative battery clamp.

When the battery clamps and the vehicle's battery are connected with the correct polarity, the power source provides electric power via the first diode to the first relay, thereby energizing the first relay and connecting the rechargeable battery of the power source with the vehicle's battery to start the vehicle. The second diode is reversely biased and the second relay is in an open state and the light in the flash light circuit does not flash.

When the two battery clamps are reversely connected to the two terminals of vehicle's battery, the first diode is in a reversed close state in the circuit of the first relay and so the first relay's normally open contact is in an off state, which leads to the disconnection of the rechargeable battery of the power source and the vehicle's battery, thereby protecting the vehicle's battery from damage and preventing high current and sparks from occurring.

The present invention can be improved by comprising a buzzer in the circuit for protecting against reverse polarity connection and short circuit of the battery clamps. The buzzer is connected in parallel with the wire coil of the second relay.

The addition of the buzzer in said circuit can put the operator on the alert of any error so that the operator can take appropriate action.

The present invention can be improved by disposing a conducting wire on one part of the positive battery clamp. The conducting wire is connected via the wire coil of the first relay and the first diode with the negative battery clamp.

By having a conducting wire on one part of the positive battery clamp, the positive battery clamp has two conducting wires, one on each part respectively. When the battery clamp is removed from the vehicle's battery, the two parts of the positive battery clamp will be instantly separated and this will cause the first relay's normally open contact to be in an off state and even if the two parts contact each other again, short circuit will not occur and so the rechargeable battery of the power source will not burnt out.

It is an object of the present invention to provide a new power source for starting motor vehicles with a circuit for protecting against reverse polarity connection and short circuit of the battery clamps.

It is another object of the present invention to provide a new power source for starting motor vehicles which is of simple and reliable construction.

It is a further object of the present invention to provide a new power source for starting motor vehicles which is susceptible of a low cost of manufacture with regard to both materials and labor, thereby making the power source for starting motor vehicles susceptible of low prices of sale and thus economically available to the buying public.

An even further object of the present invention is to provide a new power source for starting motor vehicles with an effective circuit protecting against reverse polarity connection and short circuit of the battery clamps, thus overcoming the disadvantages of the prior art.

### BRIEF DESCRIPTION OF THE DRAWINGS

FIG. 1 is a schematic diagram of the present invention.

FIG. 2 is a circuit diagram illustrating the circuit for protecting against reverse polarity connection and short circuit of the battery clamps and the flash light circuit of the present invention.

FIG. 3 shows the configuration of a battery clamp of the present invention.

### DETAILED DESCRIPTION OF THE INVENTION

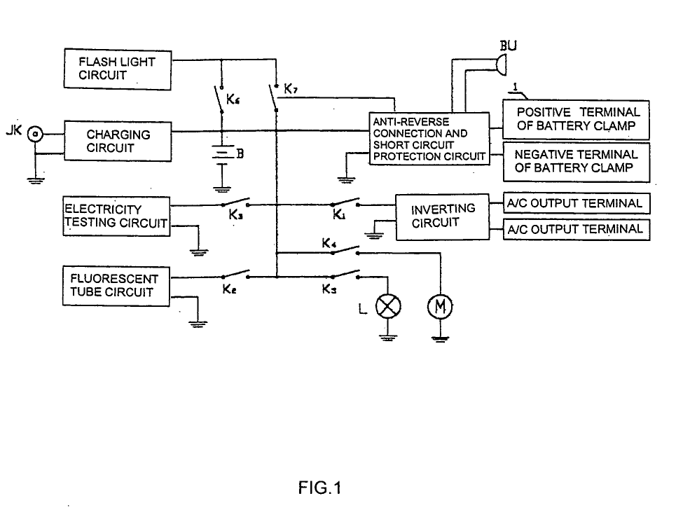

Power source with an anti-reverse connection and short circuit protection circuit for starting motor vehicles according to the present invention is hereinafter described with reference to FIGS. 1 to 3.

As illustrated in FIG. 1, the power source with an anti-reverse connection and short circuit protection circuit for starting motor vehicles generally comprises a charging circuit, an internal rechargeable battery B, a circuit for protecting against reverse polarity connection and short circuit of the battery clamps, a flash light circuit, an electricity testing circuit, an inverting circuit, a fluorescent tube circuit, a light L and an air pump M. Save for the circuit for protecting against reverse polarity connection and short circuit of the battery clamps and the flash light circuit, the other circuits are connected in ways similar to those of the current power sources for starting vehicles in the marketplace.

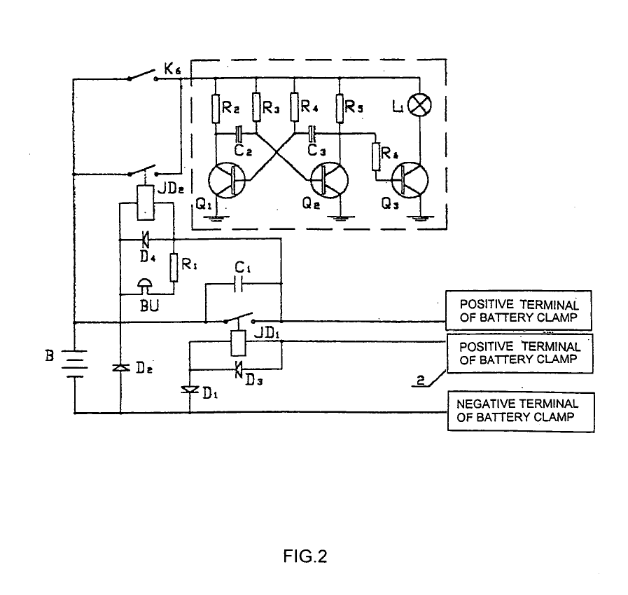

As illustrated in FIG. 2, the positive terminal of the rechargeable battery B is connected via a normally open contact relay JD1 to one part of the positive battery clamp 1. The negative terminal of the rechargeable battery B is connected to one part of the negative battery clamp. The circuit for protecting against reverse polarity connection and short circuit of the battery clamps comprises two relays JD1, JD2 and at least two diodes D1, D2; one terminal of the wire coils of the first relay JD1 and the second relay JD2 are connected to the positive battery clamp 1; the other terminal of the wire coil of the first relay JD1 is connected to the positive terminal of the first diode D1 and the negative terminal of the first diode D1 is connected to the negative battery clamp; the other terminal of the wire coil of the second relay JD2 is connected to the negative terminal of the second diode D2 and the positive terminal of the second diode D2 is connected to the negative battery clamp.

As illustrated in FIG. 2, a buzzer BU is connected in parallel with the two terminals of the second relay JD2. The buzzer BU can put the operator on the alert of any error so that the operator can change the mode of operation.

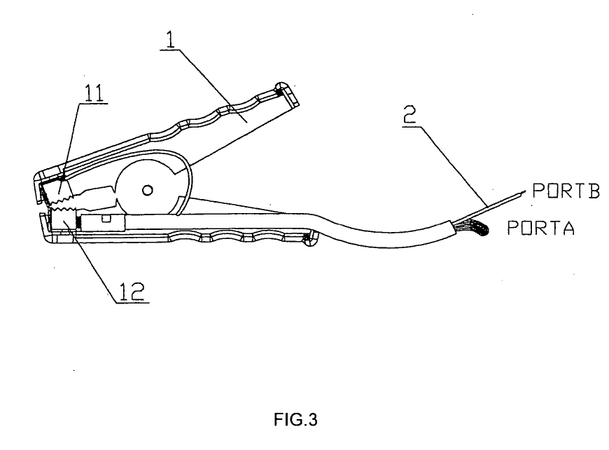

As illustrated in FIGS. 2 and 3, a conducting wire 2 is disposed on one part of the positive battery clamp 1. The conducting wire 2 is connected via the wire coil of the first relay JD1 and the first diode D1 with the negative battery clamp.

High current relays and polarity detecting circuit are used in the present invention. In normal situations, the battery clamps have no electricity and this prevents short circuit of the battery clamps. When the battery clamps are connected to the vehicle's battery, the polarity detecting circuit will detect the polarity automatically and if the polarity is correct, the circuit will allow the first relay JD1 to conduct electricity and thus connect the circuit of the rechargeable battery B and the vehicle's battery to start the vehicle. If the polarity is detected to be reversely connected, the circuit will maintain the first relay JD1 in an off state and the rechargeable battery B and the vehicle's battery are not connected and so the vehicle's battery will not be burnt out owing to the reverse polarity connection.

When the battery clamps are not connected with the vehicle's battery, the first relay JD1 has no voltage and is in an off state and the battery clamps have no electricity. This can prevent danger caused by short circuit of the battery clamps.

When the battery clamps and the vehicle's battery are connected with the correct polarity, the second diode D2 is reversely biased, the second relay JD2 is in an off state, the light L1 does not flash and the buzzer BU does not sound. The power source provides electric power via the first diode D1 to the first relay JD1, thereby energizing the first relay JD1 and connecting the rechargeable battery B with the vehicle's battery to start the vehicle.

After starting the vehicle, the operator removes the battery clamps from the vehicle's battery. The two parts 11, 12 of the positive battery clamp 1 will be instantly separated and this will cause the first relay JD1 to be in an off state and even if the two parts 11, 12 contact each other again, the first relay JD1 will remain in an off state and short circuit will not occur in the rechargeable battery B and so the rechargeable battery B will not burnt out.

When the two battery clamps are reversely connected to the two terminals of vehicle's battery, the first diode D1 is in a reversed close state in the circuit of the first relay JD1 and so the first relay JD1 remains in an off state, which leads to the disconnection of the rechargeable battery B and the vehicle's battery, thereby eliminating the risks of incurring high current and sparks. Simultaneously, the vehicle's battery provides power to the second relay JD2 and the buzzer BU via the second diode D2, thereby energizing the second relay JD2 and making the buzzer BU to sound. The rechargeable battery B provides power to the flash light circuit making the light L1 to flash.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

1. A power source with an anti-reverse connection and short circuit protection circuit for starting motor vehicles comprising a rechargeable battery, a flash light circuit, a positive battery clamp which is connected via a normally open contact relay to the positive terminal of the rechargeable battery, a negative battery clamp which is connected to the negative terminal of the rechargeable battery, and a circuit for protecting against reverse polarity connection and short circuit of the battery clamps; wherein said circuit comprises said first relay and another second relay and at least two diodes; one terminal of the wire coils of the first relay and the second relay are connected to the positive battery clamp; the other terminal of the wire coil of the first relay is connected to the positive terminal of the first diode and the negative terminal of the first diode is connected to the negative battery clamp; the other terminal of the wire coil of the second relay is connected to the negative terminal of the second diode and the positive terminal of the second diode is connected to the negative battery clamp.

2. A power source with an anti-reverse connection and short circuit protection circuit for starting motor vehicles as in claim 1, wherein said circuit also comprises a buzzer, which is connected in parallel with the wire coil of the second relay.

3. A power source with an anti-reverse connection and short circuit protection circuit for starting motor vehicles as in claim 1, wherein a conducting wire is disposed on one part of the positive battery clamp and connected via the wire coil of the first relay and the first diode with the negative battery clamp.

4. A power source with an anti-reverse connection and short circuit protection circuit for starting motor vehicles as in claim 2, wherein a conducting wire is disposed on one part of the positive battery clamp and connected via the wire coil of the first relay and the first diode with the negative battery clamp.
